(19) United States
(12) Patent Application Publication
(10) Pub. No.: US 2017/0078916 A1
(43) Pub. Date: Mar. 16, 2017

(54) DATA PROCESSING METHOD AND APPARATUS

(71) Applicant: Huawei Technologies Co., Ltd., Shenzhen (CN)

(72) Inventors: Enbo Wang, Shanghai (CN); Min Zhou, Chengdu (CN); Chenghui Peng, Munich (DE); Qiyong Zhao, Shanghai (CN); Bin Wang, Shanghai (CN)

(21) Appl. No.: 15/343,880

(22) Filed: Nov. 4, 2016

Related U.S. Application Data
(63) Continuation of application No. PCT/CN2014/076784, filed on May 5, 2014.

(51) Int. Cl. H04W 28/06; H04W 52/02

(52) U.S. Cl. CPC H04W 28/06; H04W 52/0212; H04W 88/08

(57) ABSTRACT

Embodiments of the present invention relate to the communications field, and provide a data processing method and apparatus, which can resolve a problem of excessively small capacity of a base station for data transmission, and improve capacity of the base station for data transmission. In one embodiment, a base station obtains a wireless data packet, performs protocol conversion on the wireless data packet to generate a transmission data packet, adapts the transmission data packet to generate a standard data packet, compresses and optimizes the standard data packet to generate compressed data, and adds the compressed data to a preset data packet. The present invention is used for data processing.

### CROSS-REFERENCE TO RELATED APPLICATIONS

This application is a continuation of International Application No. PCT/CN2014/076784, filed on May 5, 2014, the disclosure of which is hereby incorporated by reference in its entirety.

### TECHNICAL FIELD

The present invention relates to the communications field, and in particular, to a data processing method and apparatus.

### BACKGROUND

With unceasingly increasing mobile service requirements, a transmission capability of a backhaul network between a base station and an uplink network device becomes a bottleneck that limits station capacity. In the prior art, generally, a method for compressing data transmitted on a backhaul network is used to achieve objectives of optimizing wireless network transmission and implementing capacity expansion of a base station.

There are two compression mechanisms in an existing wireless network protocol: first, an IP (Internet Protocol, Internet Protocol) data header transmitted at an upper layer of a PDCP (Packet Data Convergence Protocol, Packet Data Convergence Protocol) layer of a radio interface protocol is compressed at the PDCP layer; second, user data is compressed at an application layer.

In the compression of the IP data header at the PDCP layer, only a protocol header of user data is compressed, which can achieve a relatively desirable effect when a protocol payload is relatively small. However, when the protocol payload is relatively large, a compression effect of the compression is greatly degraded. Although the compression of the user data at the application layer is for a protocol payload, compression is not configured for all applications. Therefore, the two manners have limited compression effects.

### SUMMARY

Embodiments of the present invention provide a data processing method and apparatus, which can resolve a problem of excessively small capacity of a base station for data transmission, and improve capacity of the base station for data transmission.

To achieve the foregoing objective, the following technical solutions are used in the embodiments of the present invention:

According to a first aspect, a data processing apparatus includes:

a baseband unit, configured to: obtain a wireless data packet, where the wireless data packet is a data packet of a wireless air interface protocol, and the wireless air interface protocol is a protocol for data transmission on a radio air interface; and perform protocol conversion on the wireless data packet to generate a transmission data packet, where the transmission data packet is a data packet of a backhaul transport protocol, and the backhaul transport protocol is a protocol for data transmission on a backhaul network between a base station and an uplink network device; and

an optimization unit, configured to: adapt the transmission data packet to generate a standard data packet, where the standard data packet is a standard Internet Protocol data packet; and compress and optimize the standard data packet to generate compressed data, and add the compressed data to a preset data packet, where the preset data packet is a data packet of the backhaul transport protocol.

According to a second aspect, a data processing apparatus includes:

a forwarding unit, configured to obtain a preset data packet;

an optimization unit, configured to: obtain compressed data from the preset data packet obtained by the forwarding unit, where the preset data packet is a data packet of a backhaul transport protocol; decompress the compressed data to obtain a standard data packet, where the standard data packet is a standard Internet Protocol data packet; and adapt the standard data packet to generate a transmission data packet, where the transmission data packet is a data packet of the backhaul transport protocol, and the backhaul transport protocol is a protocol for data transmission on a backhaul network between a base station and an uplink network device; and

a baseband unit, configured to perform protocol conversion on the transmission data packet to generate a wireless data packet, where the wireless data packet is a data packet of a wireless air interface protocol, and the wireless air interface protocol is a protocol for data transmission on a radio air interface.

According to a third aspect, a data processing apparatus includes: a processor, a memory, and a bus, where the processor and the memory are connected to each other by using the bus, where

the processor is configured to: obtain a wireless data packet, where the wireless data packet is a data packet of a wireless air interface protocol, and the wireless air interface protocol is a protocol for data transmission on a radio air interface, perform protocol conversion on the wireless data packet to generate a transmission data packet, where the transmission data packet is a data packet of a backhaul transport protocol, and the backhaul transport protocol is a protocol for data transmission on a backhaul network between a base station and an uplink network device, adapt the transmission data packet to generate a standard data packet, where the standard data packet is a standard Internet Protocol data packet, compress and optimize the standard data packet to generate compressed data, and add the compressed data to a preset data packet, where the preset data packet is a data packet of the backhaul transport protocol.

According to a fourth aspect, a data processing apparatus includes: a processor, a memory, and a bus, where the processor and the memory are connected to each other by using the bus, where

the processor is configured to: obtain a preset data packet, and obtain compressed data from the preset data packet, where the preset data packet is a data packet of a backhaul transport protocol; decompress the compressed data to obtain a standard data packet, where the standard data packet is a standard Internet Protocol data packet; adapt the standard data packet to generate a transmission data packet, where the transmission data packet is a data packet of the backhaul transport protocol, and the backhaul transport protocol is a protocol for data transmission on a backhaul network between a base station and an uplink network device; and perform protocol conversion on the transmission data packet to generate a wireless data packet, where the wireless data packet is a data packet of a wireless air interface protocol, and the wireless air interface protocol is a protocol for data transmission on a radio air interface.

With reference to the fifth aspect, in a first possible implementation manner, the adapting the transmission data packet to generate a standard data packet includes:

removing a protocol header of a transport network layer of the backhaul transport protocol from the transmission data packet to obtain the standard data packet, where the transport network layer of the backhaul transport protocol is used to carry user data.

With reference to the fifth aspect or the first possible implementation manner of the fifth aspect, in a second possible implementation manner, the compressing and optimizing the standard data packet to generate compressed data includes:

parsing the standard data packet to obtain application data;

segmenting the application data into at least one data slice, and generating at least one data digest according to the at least one data slice, where one data slice corresponds to one data digest, and the data digest is a digest of a data slice corresponding to the data digest; and

replacing a repeated data slice with a data digest corresponding to the repeated data slice, and encoding a non-repeated data slice and the data digest corresponding to the repeated data slice to generate the compressed data.

According to the data processing method and apparatus provided in the embodiments of the present invention, a wireless data packet is obtained, protocol conversion is performed on the wireless data packet to generate a transmission data packet, the transmission data packet is adapted to generate a standard data packet, the standard data packet is compressed and optimized to generate compressed data, and the compressed data is added to a preset data packet, so that a problem of excessively small capacity of a base station for data transmission can be resolved, and capacity of the base station for data transmission can be improved.

### BRIEF DESCRIPTION OF THE DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of a data processing apparatus according to an embodiment of the present invention;

FIG. 2 is a schematic structural diagram of another data processing apparatus according to an embodiment of the present invention;

FIG. 3 is a schematic structural diagram of a data processing apparatus according to an embodiment of the present invention;

FIG. 4 is a schematic structural diagram of another data processing apparatus according to an embodiment of the present invention;

FIG. 5 is a schematic flowchart of a data processing method according to an embodiment of the present invention;

FIG. 6 is a schematic flowchart of another data processing method according to an embodiment of the present invention;

FIG. 7 is a schematic flowchart of a data processing method according to another embodiment of the present invention;

FIG. 8 is a schematic flowchart of another data processing method according to another embodiment of the present invention; and

FIG. 9 is a schematic diagram of data flow of a data processing method according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

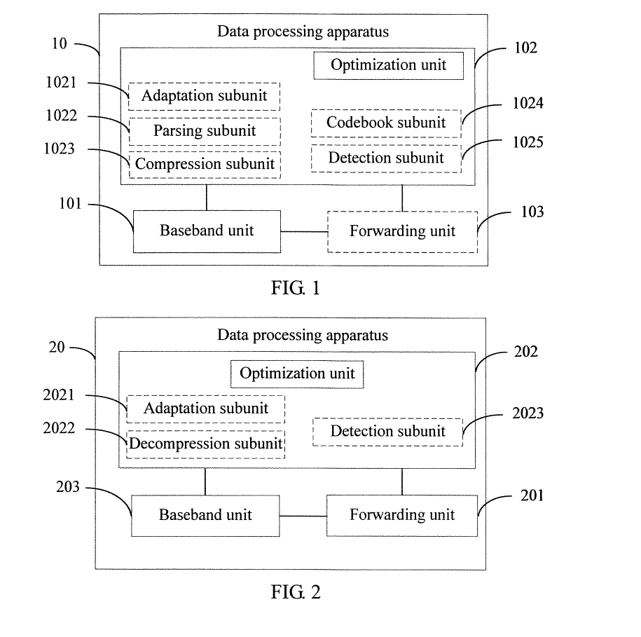

An embodiment of the present invention provides a data processing apparatus 10. Referring to FIG. 1, the data processing apparatus 10 includes a baseband unit 101 and an optimization unit 102.

The baseband unit 101 is configured to: obtain a wireless data packet, where the wireless data packet is a data packet of a wireless air interface protocol, and the wireless air interface protocol is a protocol for data transmission on a radio air interface; and perform protocol conversion on the wireless data packet to generate a transmission data packet, where the transmission data packet is a data packet of a backhaul transport protocol, and the backhaul transport protocol is a protocol for data transmission on a backhaul network between a base station and an uplink network device.

The optimization unit 102 is configured to: adapt the transmission data packet to generate a standard data packet, where the standard data packet is a standard Internet Protocol data packet; and compress and optimize the standard data packet to generate compressed data, and add the compressed data to a preset data packet, where the preset data packet is a data packet of the backhaul transport protocol.

The data processing apparatus provided in this embodiment of the present invention obtains a wireless data packet, performs protocol conversion on the wireless data packet to generate a transmission data packet, adapts the transmission data packet to generate a standard data packet, compresses and optimizes the standard data packet to generate compressed data, and adds the compressed data to a preset data packet, so that a problem of excessively small capacity of a base station for data transmission can be resolved, and capacity of the base station for data transmission can be improved.

Optionally, the optimization unit 102 includes an adaptation subunit 1021, where

the adaptation subunit 1021 is configured to split\strip a header of a transport network layer of the backhaul transport protocol from the transmission data packet to obtain the standard data packet, where the transport network layer of the backhaul transport protocol is used to carry user data.

Optionally, the optimization unit 102 further includes:

a parsing subunit 1022, configured to parse the standard data packet to obtain application data; and

a compression subunit 1023, configured to: segment the application data into at least one data slice, and generate at least one data digest according to the at least one data slice, where one data slice corresponds to one data digest, and the data digest is a digest of a data slice corresponding to the data digest; and replace a repeated data slice with a data digest corresponding to the repeated data slice, and encode a non-repeated data slice and the data digest corresponding to the repeated data slice to generate the compressed data.

Optionally, the optimization unit 102 further includes a codebook subunit 1024, where

the codebook subunit 1024 is configured to generate a data codebook according to a correspondence between the at least one data slice and the at least one data digest, where the data codebook is used to restore the compressed data into the application data.

Optionally, the apparatus further includes a forwarding unit 103, where

the forwarding unit 103 is configured to encrypt the preset data packet and transmit the encrypted preset data packet to the uplink network device.

Optionally, the optimization unit 102 further includes a detection subunit 1025, where

the detection subunit 1025 is configured to determine whether data included in the transmission data packet is data of a preset type.

The apparatus further includes a forwarding unit 103, configured to encrypt the transmission data packet and transmit the encrypted transmission data packet to the uplink network device when the data included in the transmission data packet is not the data of the preset type.

The data processing apparatus provided in this embodiment of the present invention obtains a wireless data packet, performs protocol conversion on the wireless data packet to generate a transmission data packet, adapts the transmission data packet to generate a standard data packet, compresses and optimizes the standard data packet to generate compressed data, and adds the compressed data to a preset data packet, so that a problem of excessively small capacity of a base station for data transmission can be resolved, and capacity of the base station for data transmission can be improved.

An embodiment of the present invention provides another data processing apparatus 20. Referring to FIG. 2, the data processing apparatus 20 includes a forwarding unit 201, an optimization unit 202, and a baseband unit 203.

The forwarding unit 201 is configured to obtain a preset data packet.

The optimization unit 202 is configured to: obtain compressed data from the preset data packet obtained by the forwarding unit 201, where the preset data packet is a data packet of a backhaul transport protocol; decompress the compressed data to obtain a standard data packet, where the standard data packet is a standard Internet Protocol data packet; and adapt the standard data packet to generate a transmission data packet, where the transmission data packet is a data packet of the backhaul transport protocol, and the backhaul transport protocol is a protocol for data transmission on a backhaul network between a base station and an uplink network device.

The baseband unit 203 is configured to perform protocol conversion on the transmission data packet to generate a wireless data packet, where the wireless data packet is a data packet of a wireless air interface protocol, and the wireless air interface protocol is a protocol for data transmission on a radio air interface.

The data processing apparatus provided in this embodiment of the present invention obtains a preset data packet, obtains compressed data from the preset data packet, then decompresses the compressed data to obtain a standard data packet, then adapts the standard data packet to generate a transmission data packet, finally performs protocol conversion on the transmission data packet to generate a wireless data packet, and sends the wireless data packet to user equipment, so that decompression and restoration of compressed data by a base station is implemented.

Optionally, the optimization unit 202 includes an adaptation subunit 2021, where

the adaptation subunit 2021 is configured to add a protocol header of a transport network layer of the backhaul transport protocol to the standard data packet to obtain the transmission data packet, where the transport network layer of the backhaul transport protocol is used to carry user data.

Optionally, the optimization unit 202 further includes:

a decompression subunit 2022, configured to: obtain at least one data slice and at least one data digest from the compressed data, where one data slice corresponds to one data digest, and the data digest is a digest of a data slice corresponding to the data digest; replace a repeated data digest with a data slice corresponding to the repeated data digest; and combine the at least one data slice with the data slice corresponding to the repeated data digest to obtain application data; and

an adaptation subunit 2021, configured to perform protocol encapsulation on the application data to generate the standard data packet.

Optionally, the decompression subunit 2022 is further configured to: obtain a data codebook, where the data codebook includes a correspondence between the at least one data slice and the at least one data digest, and replace, according to the data codebook, the repeated data digest with the data slice corresponding to the repeated data digest.

Optionally, the baseband unit 203 is further configured to send the wireless data packet to user equipment.

Optionally, the optimization unit 202 further includes:

a detection subunit 2023, configured to determine whether the preset data packet is a data packet that has been compressed and optimized.

The baseband unit 203 is further configured to: when the preset data packet is not the data packet that has been compressed and optimized, convert the preset data packet into a data packet of the wireless air interface protocol and send the data packet of the wireless air interface protocol to user equipment.

The data processing apparatus provided in this embodiment of the present invention obtains a preset data packet, obtains compressed data from the preset data packet, then decompresses the compressed data to obtain a standard data packet, then adapts the standard data packet to generate a transmission data packet, finally performs protocol conversion on the transmission data packet to generate a wireless data packet, and sends the wireless data packet to user equipment, so that decompression and restoration of compressed data by a base station is implemented.

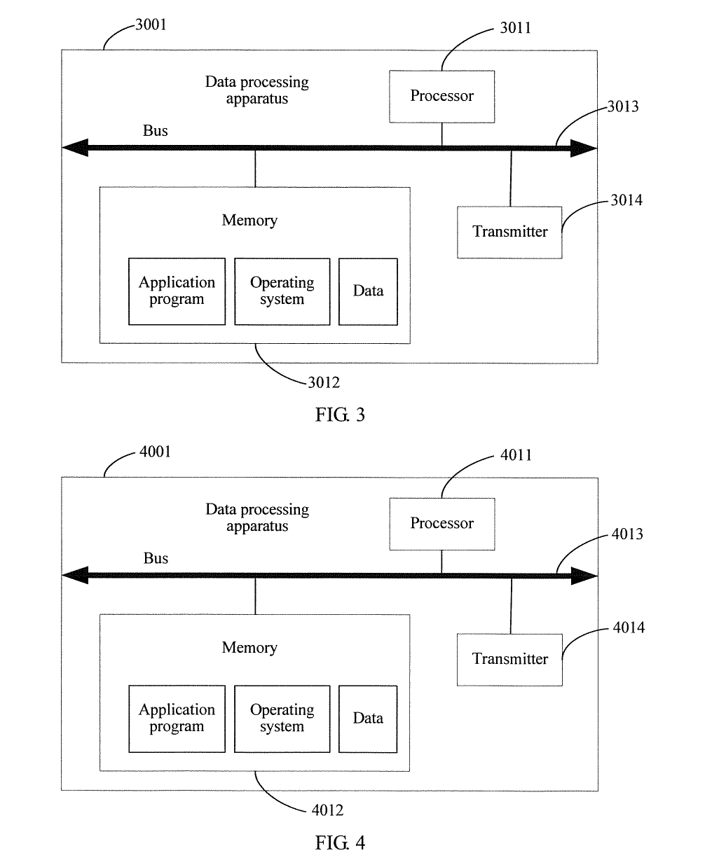

An embodiment of the present invention provides a data processing apparatus 3001. Referring to FIG. 3, the device may be built in a microprocessor computer or is a microprocessor computer. For example, the device is a portable device such as a general-purpose computer, a customized machine, a mobile phone terminal, or a tablet computer. The data processing apparatus 3001 includes: at least one processor 3011, a memory 3012, a bus 3013, and a transmitter 3014. The at least one processor 3011, the memory 3012, and the transmitter 3014 are connected to and communicate with one another by using the bus 3013.

The bus 3013 may be an ISA (Industry Standard Architecture, Industry Standard Architecture) bus, a PCI (Peripheral Component, peripheral component interconnect) bus, an EISA (Extended Industry Standard Architecture, Extended Industry Standard Architecture) bus, or the like. The bus 3013 may be an address bus, a data bus, a control bus, or the like. For convenience of indication, the bus is indicated by only one bold line in FIG. 3, but it does not indicate that there is only one bus or only one type of bus.

The memory 3012 is configured to store application program code of the solution of the present invention, where the executed application program code of the solution of the present invention is stored in the memory, and is controlled by the processor 3011 to be executed.

The memory may be a read-only memory ROM or another type of static storage device that can store static information and an instruction, or a random access memory RAM or another type of dynamic storage device that can store information and an instruction, and may also be an electrically erasable programmable read-only memory EEPROM, a compact disc read-only memory CD-ROM or other optical disk storage, optical disc storage (including a compact disc, a laser disc, an optical disc, a digital versatile disc, a Blu-ray disc, and the like), a magnetic disk storage medium or another magnetic storage device, or any other medium that can carry or store expected program code in a form of an instruction or a data structure and can be accessed by a computer, but the present invention is not limited thereto. These memories are connected to the processor by using the bus.

The processor 3011 may be a central processing unit 3011 (Central Processing Unit, CPU for short) or an application-specific integrated circuit (Application Specific Integrated Circuit, ASIC for short), or is configured as one or more integrated circuits that implement the embodiment of the present invention.

The processor 3011 is configured to invoke the program code in the memory 3012. In a possible implementation manner, when the foregoing application program is executed by the processor 3011, the following functions are implemented.

The processor 3011 is configured to: obtain a wireless data packet, where the wireless data packet is a data packet of a wireless air interface protocol, and the wireless air interface protocol is a protocol for data transmission on a radio air interface, perform protocol conversion on the wireless data packet to generate a transmission data packet, where the transmission data packet is a data packet of a backhaul transport protocol, and the backhaul transport protocol is a protocol for data transmission on a backhaul network between a base station and an uplink network device, adapt the transmission data packet to generate a standard data packet, where the standard data packet is a standard Internet Protocol data packet, compress and optimize the standard data packet to generate compressed data, and add the compressed data to a preset data packet, where the preset data packet is a data packet of the backhaul transport protocol.

The data processing apparatus provided in this embodiment of the present invention obtains a wireless data packet, performs protocol conversion on the wireless data packet to generate a transmission data packet, adapts the transmission data packet to generate a standard data packet, compresses and optimizes the standard data packet to generate compressed data, and adds the compressed data to a preset data packet, so that a problem of excessively small capacity of a base station for data transmission can be resolved, and capacity of the base station for data transmission can be improved.

Optionally, in a first application scenario, the processor 3011 is further configured to split\strip a header of a transport network layer of the backhaul transport protocol from the transmission data packet to obtain the standard data packet, where the transport network layer of the backhaul transport protocol is used to carry user data.

Optionally, in a second application scenario, the processor 3011 is further configured to: parse the standard data packet to obtain application data, segment the application data into at least one data slice, and generate at least one data digest according to the at least one data slice, where one data slice corresponds to one data digest, and the data digest is a digest of a data slice corresponding to the data digest; and replace a repeated data slice with a data digest corresponding to the repeated data slice, and encode a non-repeated data slice and the data digest corresponding to the repeated data slice to generate the compressed data.

Optionally, in a third application scenario, the processor 3011 is further configured to generate a data codebook according to a correspondence between the at least one data slice and the at least one data digest, where the data codebook is used to restore the compressed data into the application data.

Optionally, in a fourth application scenario, the processor 3011 is further configured to encrypt the preset data packet and use the transmitter 3014 to transmit the encrypted preset data packet to the uplink network device.

Optionally, in a fifth application scenario, the processor 3011 is further configured to: determine whether data included in the transmission data packet is data of a preset type, and when the data included in the transmission data packet is not the data of the preset type, encrypt the transmission data packet and use the transmitter 3014 to transmit the encrypted transmission data packet to the uplink network device.

The data processing apparatus provided in this embodiment of the present invention obtains a wireless data packet, performs protocol conversion on the wireless data packet to generate a transmission data packet, adapts the transmission data packet to generate a standard data packet, compresses and optimizes the standard data packet to generate compressed data, and adds the compressed data to a preset data packet, so that a problem of excessively small capacity of a base station for data transmission can be resolved, and capacity of the base station for data transmission can be improved.

An embodiment of the present invention provides another data processing apparatus 4001. Referring to FIG. 4, the device may be built in a microprocessor computer or is a microprocessor computer. For example, the device is a portable device such as a general-purpose computer, a customized machine, a mobile phone terminal, or a tablet. The data processing apparatus 4001 includes: at least one processor 4011, a memory 4012, a bus 4013, and a transmitter 4014. The at least one processor 4011, the memory 4012, and the transmitter 4014 are connected to and communicate with one another by using the bus 4013.

The bus 4013 may be an ISA (Industry Standard Architecture, Industry Standard Architecture) bus, a PCI (Peripheral Component, peripheral component interconnect) bus, an EISA (Extended Industry Standard Architecture, Extended Industry Standard Architecture) bus, or the like. The bus 4013 may be an address bus, a data bus, a control bus, or the like. For convenience of indication, the bus is indicated by only one bold line in FIG. 4, but it does not indicate that there is only one bus or only one type of bus.

The memory 4012 is configured to execute application program code of the solution of the present invention, where the executed application program code of the solution of the present invention is stored in the memory, and is controlled by the processor 4011 to be executed.

The memory may be a read-only memory ROM or another type of static storage device that can store static information and an instruction, or a random access memory RAM or another type of dynamic storage device that can store information and an instruction, and may also be an electrically erasable programmable read-only memory EEPROM, a compact disc read-only memory CD-ROM or other optical disk storage, optical disc storage (including a compact disc, a laser disc, an optical disc, a digital versatile disc, a Blu-ray disc, and the like), a magnetic disk storage medium or another magnetic storage device, or any other medium that can carry or store expected program code in a form of an instruction or a data structure and can be accessed by a computer, but the present invention is not limited thereto. These memories are connected to the processor by using the bus.

The processor 4011 may be a central processing unit 4011 (Central Processing Unit, CPU for short) or an application-specific integrated circuit (Application Specific Integrated Circuit, ASIC for short), or is configured as one or more integrated circuits that implement the embodiment of the present invention.

The processor 4011 is configured to invoke the program code in the memory 4012. In a possible implementation manner, when the foregoing application program is executed by the processor 4011, the following functions are implemented.

The processor is configured to: obtain a preset data packet, and obtain compressed data from the preset data packet, where the preset data packet is a data packet of a backhaul transport protocol; decompress the compressed data to obtain a standard data packet, where the standard data packet is a standard Internet Protocol data packet; adapt the standard data packet to generate a transmission data packet, where the transmission data packet is a data packet of the backhaul transport protocol, and the backhaul transport protocol is a protocol for data transmission on a backhaul network between a base station and an uplink network device; and perform protocol conversion on the transmission data packet to generate a wireless data packet, where the wireless data packet is a data packet of a wireless air interface protocol, and the wireless air interface protocol is a protocol for data transmission on a radio air interface.

The data processing apparatus provided in this embodiment of the present invention obtains a preset data packet, obtains compressed data from the preset data packet, then decompresses the compressed data to obtain a standard data packet, then adapts the standard data packet to generate a transmission data packet, finally performs protocol conversion on the transmission data packet to generate a wireless data packet, and sends the wireless data packet to user equipment, so that decompression and restoration of compressed data by a base station is implemented.

Optionally, in a first application scenario, the processor 4011 is further configured to add a protocol header of a transport network layer of the backhaul transport protocol to the transmission data packet to obtain the transmission data packet, where the transport network layer of the backhaul transport protocol is used to carry user data.

Optionally, in a second application scenario, the processor 4011 is further configured to: obtain at least one data slice and at least one data digest from the compressed data, where one data slice corresponds to one data digest, and the data digest is a digest of a data slice corresponding to the data digest; replace a repeated data digest with a data slice corresponding to the repeated data digest; combine the at least one data slice with the data slice corresponding to the repeated data digest to obtain application data; and perform protocol encapsulation on the application data to generate the standard data packet.

Optionally, in a third application scenario, the processor 4011 is further configured to: obtain a data codebook, where the data codebook includes a correspondence between the at least one data slice and the at least one data digest, and replace, according to the data codebook, the repeated data digest with the data slice corresponding to the repeated data digest.

Optionally, in a fourth application scenario, the processor 4011 is further configured to use the transmitter 4014 to send the wireless data packet to user equipment.

Optionally, in a fifth application scenario, the processor 4011 is further configured to: determine whether the preset data packet is a data packet that has been compressed and optimized, and when the preset data packet is not the data packet that has been compressed and optimized, convert the preset data packet into a data packet of the wireless air interface protocol and use the transmitter 4014 to send the data packet of the wireless air interface protocol to user equipment.

The data processing apparatus provided in this embodiment of the present invention obtains a preset data packet, obtains compressed data from the preset data packet, then decompresses the compressed data to obtain a standard data packet, then adapts the standard data packet to generate a transmission data packet, finally performs protocol conversion on the transmission data packet to generate a wireless data packet, and sends the wireless data packet to user equipment, so that decompression and restoration of compressed data by a base station is implemented.

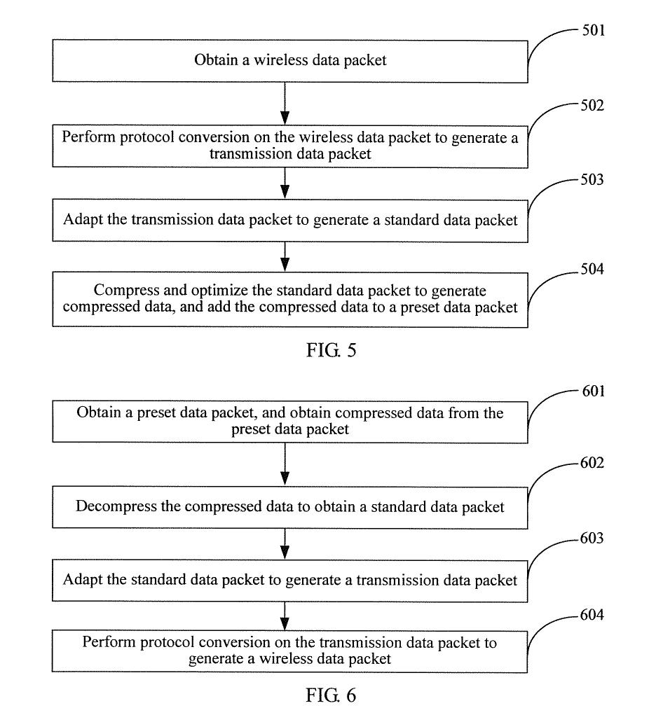

An embodiment of the present invention provides a data processing method. Referring to FIG. 5, the method includes the following steps:

501. Obtain a wireless data packet.

The wireless data packet is a data packet of a wireless air interface protocol, and the wireless air interface protocol is a protocol for data transmission on a radio air interface.

502. Perform protocol conversion on the wireless data packet to generate a transmission data packet.

The transmission data packet is a data packet of a backhaul transport protocol, and the backhaul transport protocol is a protocol for data transmission on a backhaul network between a base station and an uplink network device.

Optionally, in an application scenario, the wireless data packet is used for data transmission between a base station and user equipment, and the transmission data packet is used for data transmission on a backhaul network between the base station and an uplink network device. Therefore, when the base station receives a wireless data packet sent by the user equipment, the base station needs to convert a wireless air interface protocol into a backhaul transport protocol by means of protocol conversion, that is, convert the wireless data packet into the transmission data packet, and then the base station can transmit the transmission data packet to the uplink network device.

503. Adapt the transmission data packet to generate a standard data packet.

The standard data packet is a standard Internet Protocol data packet.

Optionally, in a wireless communications network, to improve capacity of abase station for data transmission, a transmission data packet of a backhaul network between the base station and an uplink network device may be optimized. Specifically, to facilitate compression of data, the transmission data packet is adapted into a standard Internet Protocol data packet, and the standard Internet Protocol data packet is further compressed and optimized.

504. Compress and optimize the standard data packet to generate compressed data, and add the compressed data to a preset data packet.

The preset data packet is a data packet of the backhaul transport protocol.

Specifically, optionally, in a wireless communications network, as an amount of user data unceasingly increases, a capability of a base station for data processing also needs to be constantly improved. To compress and optimize user data is an effective means of expanding capacity of the base station. In this embodiment of the present invention, a standard data packet is compressed and optimized to obtain compressed data, then the compressed data is added to a preset data packet, and the preset data packet is sent to an uplink network device. In this way, the standard data packet is compressed into compressed data of relatively small capacity, a data size is reduced, and further a bandwidth, occupied by data transmission, of a backhaul network is reduced, thereby improving capacity of a base station for data transmission.

According to the data processing method provided in this embodiment of the present invention, a wireless data packet is obtained, protocol conversion is performed on the wireless data packet to generate a transmission data packet, the transmission data packet is adapted to generate a standard data packet, the standard data packet is compressed and optimized to generate compressed data, and the compressed data is added to a preset data packet, so that a problem of excessively small capacity of a base station for data transmission can be resolved, and capacity of the base station for data transmission can be improved.

Based on the foregoing embodiment corresponding to FIG. 5, an embodiment of the present invention provides another data processing method. Referring to FIG. 6, the method includes the following steps:

601. Obtain a preset data packet, and obtain compressed data from the preset data packet.

The preset data packet is a data packet of a backhaul transport protocol.

Specifically, optionally, it is determined, by identifying a compression identifier, whether the preset data packet is a data packet obtained after compression and optimization. With reference to the embodiment corresponding to FIG. 5, when the compressed data is added to the preset data packet, a compression identifier may be added to the preset data packet, to facilitate identification.

602. Decompress the compressed data to obtain a standard data packet.

The standard data packet is a standard Internet Protocol data packet.

Optionally, corresponding to the foregoing embodiment corresponding to FIG. 5, the compressed data is decompressed, and the decompression is an inverse process of compression and optimization. The compressed data in the preset data packet is restored into the standard data packet after decompression.

603. Adapt the standard data packet to generate a transmission data packet.

The transmission data packet is a data packet of a backhaul transport protocol, and the backhaul transport protocol is a protocol for data transmission on a backhaul network between a base station and an uplink network device.

Optionally, corresponding to the description in step 503 of the foregoing embodiment corresponding to FIG. 5, the standard data packet obtained after decompression in step 602 is adapted into a transmission data packet, so that the transmission data packet is transmitted within the base station.

604. Perform protocol conversion on the transmission data packet to generate a wireless data packet.

The wireless data packet is a data packet of a wireless air interface protocol, and the wireless air interface protocol is a protocol for data transmission on a radio air interface.

Optionally, corresponding to the description of step 502 in the foregoing embodiment corresponding to FIG. 5, protocol conversion is performed on the transmission data packet to obtain a wireless data packet, and the wireless data packet is sent to user equipment by using a radio air interface.

According to the data processing method provided in this embodiment of the present invention, a preset data packet is obtained, compressed data is obtained from the preset data packet, then the compressed data is decompressed to obtain a standard data packet, then the standard data packet is adapted to generate a transmission data packet, finally protocol conversion is performed on the transmission data packet to generate a wireless data packet, and the wireless data packet is sent to user equipment, so that decompression and restoration of compressed data by a base station is implemented.

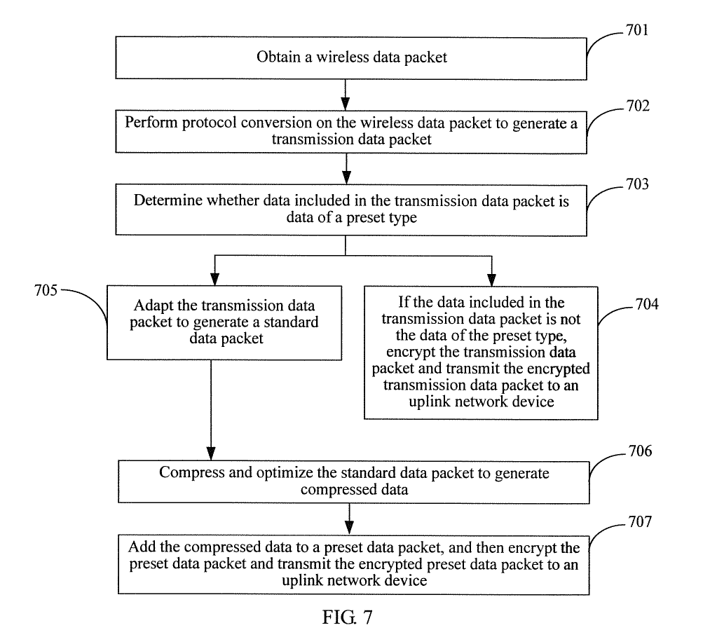

Based on the foregoing embodiment corresponding to FIG. 5, another embodiment of the present invention provides a data processing method. Referring to FIG. 7, the method includes the following steps:

701. Obtain a wireless data packet.

The wireless data packet is a data packet of a wireless air interface protocol, and the wireless air interface protocol is a protocol for data transmission on a radio air interface.

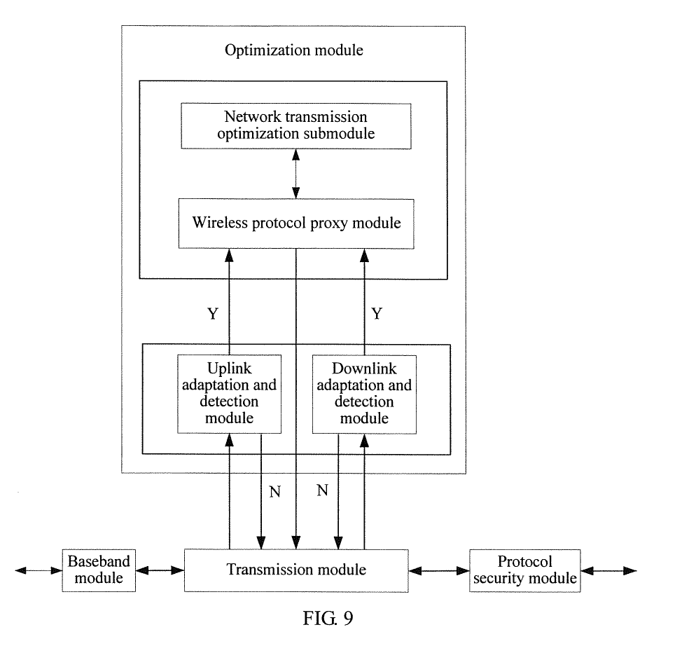

Optionally, the wireless air interface protocol includes: a PDCP protocol, an RLC (Radio Link Control, Radio Link Control) protocol, a MAC (Media Access Control, Media Access Control) protocol, and a physical layer protocol. Referring to FIG. 9, a data transmission path from user equipment to a backhaul network is an uplink path, and a data transmission path from the backhaul network to the user equipment is a downlink path. The uplink path indicates a direction of data flow in a data transmission method described in the embodiment corresponding to FIG. 7. Specifically, a baseband module and a transport module in FIG. 9 correspond to the baseband unit described in the embodiment corresponding to FIG. 1, and an uplink adaptation and detection module corresponds to the detection subunit in the embodiment corresponding to FIG. 1. A wireless protocol proxy module corresponds to the adaptation subunit in the embodiment corresponding to FIG. 1, and a network transmission optimization submodule corresponds to the compression subunit, the parsing subunit, and the codebook subunit in the embodiment corresponding to FIG. 1. The network transmission optimization submodule and the wireless protocol proxy form a wireless network transmission optimization module. A wireless network transmission optimization submodule and the uplink adaptation and detection module in FIG. 9 form an optimization module, and the optimization module corresponds to the optimization unit in the embodiment corresponding to FIG. 1. Herein, specifically, the baseband module obtains the wireless data packet.

702. Perform protocol conversion on the wireless data packet to generate a transmission data packet.

The transmission data packet is a data packet of a backhaul transport protocol, and the backhaul transport protocol is a protocol for data transmission on a backhaul network between a base station and an uplink network device.

Optionally, the backhaul transport protocol includes a radio network layer and a transport network layer. The radio network layer includes a standard IP (Internet Protocol, Internet Protocol) data packet that carries application data. The transport network layer includes: the GTP-U (GTP User, GPRS Tunneling Protocol-User Plane), the UDP (User Datagram Protocol, User Datagram Protocol), the IP (Internet Protocol, Internet Protocol), a data link layer protocol, and a physical layer protocol.

Optionally, in an application scenario, for an LTE (Long Term Evolution, Long Term Evolution) system, the wireless data packet is used for data transmission between a base station and user equipment, and the transmission data packet is used for data transmission on a backhaul network between the base station and an uplink network device. Therefore, after receiving a wireless data packet from a radio air interface, the base station needs to convert the wireless data packet into a transmission data packet by means of protocol conversion, that is, convert a wireless air interface protocol into a backhaul transport protocol on the backhaul network between the base station and the uplink network device. The application data is included in a standard Internet Protocol data packet and encapsulated into the transmission data packet. Referring to FIG. 9, a baseband module performs the protocol conversion on the wireless data packet.

703. Determine whether data included in the transmission data packet is data of a preset type.

Optionally, the transmission data packet is detected. It is determined, by means of detection, whether the transmission data packet needs to be compressed and optimized. Specifically, if the transmission data packet carries user data, the transmission data packet needs to be compressed and optimized.

Specifically, optionally, it is detected whether an IP address of the transmission data packet meets a preset IP address filter rule. If the IP address of the transmission data packet meets the preset IP address filter rule, a protocol type of an IP header of the transmission data packet is determined. If the protocol type of the IP header of the transmission data packet is UDP, it is detected whether a UDP destination port number is a GTP-U port number. If yes, it indicates that the transmission data packet is a data packet that carries user data, and the transmission data packet needs to be compressed and optimized. Referring to FIG. 9, the uplink adaptation and detection module determines whether data included in the transmission data packet is data of a preset type.

704. If the data included in the transmission data packet is not the data of the preset type, encrypt the transmission data packet and transmit the encrypted transmission data packet to the uplink network device.

Optionally, with reference to step 703, if the transmission data packet is not a transmission data packet that carries user data, the transmission data packet does not need to be compressed and optimized. The transmission data packet is encrypted and transmitted to the uplink network device, or is directly transmitted to the uplink network device without being encrypted.

If the data included in the transmission data packet is the data of the preset type, the transmission data packet needs to be compressed and optimized. Specifically, after step 703, the method further includes:

705. Adapt the transmission data packet to generate a standard data packet.

The transmission data packet that has been detected and that needs to be compressed and optimized is adapted, to generate a standard data packet.

Referring to FIG. 9, the wireless protocol proxy module adapts the transmission data packet to generate a standard data packet. Specifically, a GTP-U protocol proxy may be selected. The GTP-U protocol proxy strips IP, UDP, and GTP-U headers of a transport network layer of a backhaul transport protocol, to obtain a standard data packet that carries application data, then parses a TCP (Transmission Control Protocol, Transmission Control Protocol)/UDP header of the standard data packet, and records a mapping relationship between the stripped IP, UDP, and GTP-U headers of the transport network layer of the backhaul transport protocol and the TCP/UDP header of the standard data packet, so that after the standard data packet is compressed and optimized, the stripped IP, UDP, and GTP-U headers of the transport network layer of the backhaul transport protocol are added again.

Alternatively, a UDP protocol proxy may be selected. The entire standard Internet Protocol data packet in the transmission data packet is used as application data. In this way, the transmission data packet may be used as a standard data packet and directly compressed and optimized.

706. Compress and optimize the standard data packet to generate compressed data.

Optionally, the standard data packet is parsed to obtain application data. The application data is segmented into at least one data slice, and a data digest is generated according to a data slice, where one data slice corresponds to one data digest, and the data digest is a digest of the data slice corresponding to the data digest. The data digest is only a digest of the data slice corresponding to the data digest, and capacity occupied by the data digest is smaller than capacity occupied by the data slice. A codebook is generated according to a correspondence between the data digest and the data slice, where the codebook is used to restore the data digest into application data. A repeated data slice is replaced with a data digest corresponding to the data slice, and a non-repeated data slice and the data digest corresponding to the repeated data slice are encoded to generate compressed data. In this way, a data slice having relatively large capacity is replaced with a data digest that corresponds to the data slice and that has relatively small capacity, and then encoding is performed to generate compressed data, which reduces data capacity. Referring to FIG. 9, the network transmission optimization submodule compresses and optimizes the standard data packet to generate compressed data.

707. Add the compressed data to a preset data packet, and then encrypt the preset data packet and transmit the encrypted preset data packet to an uplink network device.

The preset data packet is a data packet of the backhaul transport protocol.

Optionally, when multiple transmission data packets are compressed and optimized, multiple pieces of compressed data are generated for the multiple transmission data packets. One or more pieces of compressed data are encapsulated into one standard Internet Protocol data packet, and then the standard Internet Protocol data packet is adapted to obtain a preset data packet. Herein, the adaptation means to convert an Internet Protocol data packet into a data packet of the backhaul transport protocol. Referring to FIG. 9, the wireless protocol proxy module completes the adaptation.

With reference to step 705, the GTP-U protocol proxy restores the stripped IP, UDP, and GTP-U headers of the transport network layer of the backhaul transport protocol according to the mapping relationship recorded in step 705, to obtain a data packet of the backhaul transport protocol, that is, the preset data packet. Alternatively, when the UDP protocol proxy is used, a data packet that is obtained after compression and optimization is already a data packet of a wireless transmission protocol, and may be directly transmitted.

The transmission data is encrypted and transmitted to the uplink network device, or is directly transmitted to the uplink network device without being encrypted.

In this way, a data optimization function is added to an existing base station architecture, a transmission data packet is determined, and a transmission data packet that carries user data is selected to be compressed and optimized, which reduces a bandwidth, occupied by data transmission, of a backhaul network, and implements optimization of data transmission in the backhaul network.

According to the data processing method provided in this embodiment of the present invention, a wireless data packet is obtained, protocol conversion is performed on the wireless data packet to generate a transmission data packet, the transmission data packet is then adapted to generate a standard data packet, the standard data packet is finally compressed and optimized to generate compressed data, and the compressed data is added to a preset data packet, so that a problem of excessively small capacity of a base station for data transmission can be resolved, and capacity of the base station for data transmission can be improved.

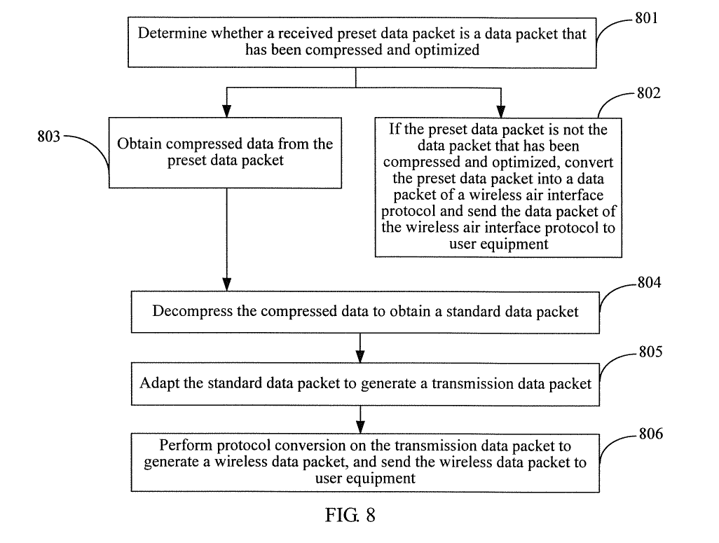

Based on the foregoing embodiment corresponding to FIG. 6, another embodiment of the present invention provides another data processing method. Referring to FIG. 8, the method includes the following steps:

801. Determine whether a received preset data packet is a data packet that has been compressed and optimized.

In an application scenario, after receiving a preset data packet sent by an uplink network device, an LTE base station detects the data packet, and determines, by means of the detection, whether the preset data packet has been compressed and optimized.

Optionally, it is determined, by identifying a compression identifier, whether the preset data packet is a data packet obtained after compression and optimization. With reference to the description of step 707 in the embodiment corresponding to FIG. 7, when compressed data is added to the preset data packet, a compression identifier may be added to the preset data packet, so as to determine whether the preset data packet is a data packet that has been compressed and optimized. Specifically, optionally, a wireless protocol proxy GTP-U or a wireless protocol proxy UDP adapts an Internet Protocol data packet into a data packet of a backhaul transport protocol, and modifies a UDP destination port number of a transmission data packet, so as to add a compression identifier to the preset data packet. Referring to FIG. 9, a data transmission path from a backhaul network to user equipment is a downlink path, and a data transmission path from the user equipment to the backhaul network is an uplink path. The downlink path indicates a direction of data flow in a data transmission method described in the embodiment corresponding to FIG. 8. Specifically, a baseband module and a transport module in FIG. 8 correspond to the baseband unit described in the embodiment corresponding to FIG. 2, and a downlink adaptation and detection module corresponds to the detection subunit in the embodiment corresponding to FIG. 2. A wireless protocol proxy module corresponds to the adaptation subunit in the embodiment corresponding to FIG. 2, and a network transmission optimization submodule corresponds to the decompression subunit in the embodiment corresponding to FIG. 2. The network transmission optimization submodule and the wireless protocol proxy form a wireless network transmission optimization module. A wireless network transmission optimization submodule and the downlink adaptation and detection module in FIG. 8 form an optimization module, and the optimization module corresponds to the optimization unit in the embodiment corresponding to FIG. 2. Herein, specifically, the downlink adaptation and detection module determines whether the received preset data packet is a data packet that has been compressed and optimized.

802. If the preset data packet is not the data packet that has been compressed and optimized, convert the preset data packet into a data packet of a wireless air interface protocol and send the data packet of the wireless air interface protocol to user equipment.

If the preset data packet is the data packet that is obtained after compression and optimization, after step 801, the method further includes:

803. Obtain compressed data from the preset data packet.

The preset data packet is parsed to obtain the compressed data in the preset data packet.

Optionally, corresponding to step 705 in Embodiment 7, referring to FIG. 9, the wireless protocol proxy performs processing and obtains a standard data packet that carries the compressed data, and then the network transmission optimization submodule obtains the compressed data. Specifically, when a GTP-U protocol proxy is used, the GTP-U protocol proxy strips IP, UDP, and GTP-U headers of a transport network layer of a backhaul transport protocol, to obtain a standard data packet that carries the compressed data, then parses a TCP/UDP header of the standard data packet, and records a mapping relationship between the stripped IP, UDP, and GTP-U headers of the transport network layer of the backhaul transport protocol and the TCP/UDP header of the standard data packet, so that after the standard data packet is decompressed, the stripped IP, UDP, and GTP-U headers of the transport network layer of the backhaul transport protocol are added again. The compressed data is obtained after the standard data packet is parsed. Alternatively, when a UDP protocol proxy is used, the preset data packet is directly parsed to obtain the compressed data.

804. Decompress the compressed data to obtain a standard data packet.

The standard data packet is a standard Internet Protocol data packet.

Optionally, corresponding to step 706 in the embodiment corresponding to FIG. 7, the decompression is an inverse process of compression and optimization. At least one data slice and at least one data digest are obtained from the compressed data, a repeated data digest is replaced, by using an obtained data codebook, with a data slice corresponding to the repeated data digest, where the data codebook includes a correspondence between the at least one data digest and the at least one data slice, one data digest corresponds to one data slice, and the data digest is a digest of a data slice corresponding to the data digest. In this way, the compressed data is restored into application data, and protocol encapsulation is performed on the application data to generate the standard data packet. Referring to FIG. 9, the network transmission optimization submodule decompresses the compressed data.

805. Adapt the standard data packet to generate a transmission data packet.

The transmission data packet is a data packet of a backhaul transport protocol, and the backhaul transport protocol is a protocol for data transmission on a backhaul network between a base station and an uplink network device.

Optionally, with reference to step 803, referring to FIG. 9, a wireless communications protocol proxy adapts the standard data packet to generate the transmission data packet. Specifically, the GTP-U protocol proxy restores the stripped IP, UDP, and GTP-U headers of the transport network layer of the backhaul transport protocol according to the mapping relationship recorded in step 803, to obtain a data packet of the backhaul transport protocol, that is, the transmission data packet. Alternatively, when the UDP protocol proxy is used, a data packet that is obtained after decompression is already a data packet of a wireless transmission protocol, that is, the transmission data packet, and may be directly transmitted.

806. Perform protocol conversion on the transmission data packet to generate a wireless data packet, and send the wireless data packet to user equipment.

The wireless data packet is a data packet of a wireless air interface protocol, and the wireless air interface protocol is a protocol for data transmission on a radio air interface.

Optionally, in a wireless communications application scenario, an LTE base station needs to send user data to user equipment by using a radio air interface. A wireless data packet is used for data transmission between the base station and the user equipment, and a transmission data packet is used for data transmission on a backhaul network between the base station and an uplink network device. Therefore, before sending the user data by using the radio air interface, the base station needs to convert the transmission data packet into a wireless data packet by means of protocol conversion, that is, convert a backhaul transport protocol into a wireless air interface protocol. After the conversion is completed, the wireless data packet is sent to the user equipment by using the radio air interface. Referring to FIG. 9, the protocol conversion is performed by the baseband module.

According to the data processing method provided in this embodiment of the present invention, it is determined whether a received preset data packet is a data packet that has been compressed and optimized, compressed data is obtained from a preset data packet that is obtained after compression and optimization, the compressed data is decompressed to obtain a standard data packet, the standard data packet is adapted to generate a transmission data packet, protocol conversion is performed on the transmission data packet to generate a wireless data packet, and the wireless data packet is sent to user equipment, so that decompression and restoration of compressed data by a base station is implemented.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM (Random Access Memory, random access memory), a ROM (Read-Only Memory, read-only memory), an EEPROM (Electrically Erasable Programmable Read-Only Memory, electrically erasable programmable read-only memory), a CD-ROM (Compact Disc Read-Only Memory, compact disc read-only memory) or other optical disc storage, a disk storage medium or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source by using a coaxial cable, an optical fiber/cable, a twisted pair, a DSL (Digital Subscriber Line, digital subscriber line) or wireless technologies such as infrared ray, radio and microwave, the coaxial cable, optical fiber/cable, twisted pair, DSL or wireless technologies such as infrared ray, radio and microwave are included in a definition of a medium to which they belong. For example, a disk and disc used by the present invention includes a CD (Compact Disc, compact disc), a laser disc, an optical disc, a DVD (Digital Versatile Disc, digital versatile disc), a floppy disk and a Blu-ray disc, where the disk generally copies data by a magnetic means, and the disc copies data optically by a laser means. The foregoing combination should also be included in the protection scope of the computer-readable medium.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A data processing apparatus, comprising:
a processor;
a memory; and
a bus;
wherein the processor and the memory are connected to each other by using the bus, wherein the processor is configured to:
obtain a wireless data packet, wherein the wireless data packet is a data packet of a wireless air interface protocol, and the wireless air interface protocol is a protocol for data transmission on a radio air interface;
perform protocol conversion on the wireless data packet to generate a transmission data packet, wherein the transmission data packet is a data packet of a backhaul transport protocol, and the backhaul transport protocol is a protocol for data transmission on a backhaul network between a base station and an uplink network device;
adapt the transmission data packet to generate a standard data packet, wherein the standard data packet is a standard Internet Protocol data packet;
compress and optimize the standard data packet to generate compressed data; and
add the compressed data to a preset data packet, wherein the preset data packet is a data packet of the backhaul transport protocol.

2. The apparatus according to claim 1 wherein the processor is further configured to:
strip a header of a transport network layer of the backhaul transport protocol from the transmission data packet to obtain the standard data packet, wherein the transport network layer of the backhaul transport protocol is used to carry user data.

3. The apparatus according to claim 1, wherein the processor is further configured to:
parse the standard data packet to obtain application data;
segment the application data into at least one data slice;
generate at least one data digest according to the at least one data slice, wherein one data slice corresponds to one data digest, and the data digest is a digest of a data slice corresponding to the data digest;
replace a repeated data slice with a data digest corresponding to the repeated data slice; and
encode a non-repeated data slice and the data digest corresponding to the repeated data slice to generate the compressed data.

4. The apparatus according to claim 3, wherein the processor is further configured to:
generate a data codebook according to a correspondence between the at least one data slice and the at least one data digest, wherein the data codebook is used to restore the compressed data into the application data.

5. The apparatus according to claim 1, wherein the data processing apparatus further comprises:
a transmitter; and
the processor is further configured to:
encrypt the preset data packet and use the transmitter to transmit the encrypted preset data packet to the uplink network device.

6. The apparatus according to claim 1, wherein the data processing apparatus further comprises:
a transmitter; and
the processor is further configured to:
determine whether data comprised in the transmission data packet is data of a preset type, and when the data comprised in the transmission data packet is not the data of the preset type, encrypt the transmission data packet and use the transmitter to transmit the encrypted transmission data packet to the uplink network device.

7. A data processing apparatus, comprising:
a processor;
a memory; and
a bus;
wherein the processor and the memory are connected to each other by using the bus, wherein the processor is configured to:
obtain a preset data packet, and obtain compressed data from the preset data packet, wherein the preset data packet is a data packet of a backhaul transport protocol;
decompress the compressed data to obtain a standard data packet, wherein the standard data packet is a standard Internet Protocol data packet;
adapt the standard data packet to generate a transmission data packet, wherein the transmission data packet is a data packet of the backhaul transport protocol, and the backhaul transport protocol is a protocol for data transmission on a backhaul network between a base station and an uplink network device; and
perform protocol conversion on the transmission data packet to generate a wireless data packet, wherein the wireless data packet is a data packet of a wireless air interface protocol, and the wireless air interface protocol is a protocol for data transmission on a radio air interface.

8. The apparatus according to claim 7, wherein the processor is further configured to:
add a protocol header of a transport network layer of the backhaul transport protocol to the standard data packet to obtain the transmission data packet, wherein the transport network layer of the backhaul transport protocol is used to carry user data.

9. The apparatus according to claim 8, wherein the processor is further configured to:
obtain at least one data slice and at least one data digest from the compressed data, wherein one data slice corresponds to one data digest, and the data digest is a digest of a data slice corresponding to the data digest;
replace a repeated data digest with a data slice corresponding to the repeated data digest;
combine the at least one data slice with the data slice corresponding to the repeated data digest to obtain application data; and
perform protocol encapsulation on the application data to generate the standard data packet.

10. The apparatus according to claim 9, wherein the processor is further configured to:
obtain a data codebook, wherein the data codebook comprises a correspondence between the at least one data slice and the at least one data digest; and
replace, according to the data codebook, the repeated data digest with the data slice corresponding to the repeated data digest.

11. The apparatus according to claim 7, wherein the data processing apparatus further comprises:
a transmitter; and
the processor is further configured to:
use the transmitter to send the wireless data packet to user equipment.

12. The apparatus according to claim 7, wherein the data processing apparatus further comprises:
a transmitter; and
the processor is further configured to:
determine whether the preset data packet is a data packet that has been compressed and optimized, and when the preset data packet is not the data packet that has been compressed and optimized, convert the preset data packet into a data packet of the wireless air interface protocol and use the transmitter to send the data packet of the wireless air interface protocol to user equipment.

13. A data processing method, the method comprising:
obtaining a wireless data packet, wherein the wireless data packet is a data packet of a wireless air interface protocol, and the wireless air interface protocol is a protocol for data transmission on a radio air interface;
performing protocol conversion on the wireless data packet to generate a transmission data packet, wherein the transmission data packet is a data packet of a backhaul transport protocol, and the backhaul transport protocol is a protocol for data transmission on a backhaul network between a base station and an uplink network device;
adapting the transmission data packet to generate a standard data packet, wherein the standard data packet is a standard Internet Protocol data packet;
compressing and optimizing the standard data packet to generate compressed data; and
adding the compressed data to a preset data packet, wherein the preset data packet is a data packet of the backhaul transport protocol.

14. The method according to claim 13, wherein adapting the transmission data packet to generate the standard data packet comprises:
removing a protocol header of a transport network layer of the backhaul transport protocol from the transmission data packet to obtain the standard data packet, wherein the transport network layer of the backhaul transport protocol is used to carry user data.

15. The method according to claim 13, wherein compressing and optimizing the standard data packet to generate compressed data comprises:
parsing the standard data packet to obtain application data;
segmenting the application data into at least one data slice, and generating at least one data digest according to the at least one data slice, wherein one data slice corresponds to one data digest, and the data digest is a digest of a data slice corresponding to the data digest;
replacing a repeated data slice with a data digest corresponding to the repeated data slice; and
encoding a non-repeated data slice and the data digest corresponding to the repeated data slice to generate the compressed data.

16. The method according to claim 14, further comprising:
generating a data codebook according to a correspondence between the at least one data slice and the at least one data digest, wherein the data codebook is used to restore the compressed data into the application data.

17. The method according to claim 13, further comprising:
after adding the compressed data to the preset data packet, encrypting the preset data packet and transmitting the encrypted preset data packet to the uplink network device.

18. The method according to claim 13, further comprising:
after performing protocol conversion on the wireless data packet to generate the transmission data packet, determining whether data comprised in the transmission data packet is data of a preset type; and
when the data comprised in the transmission data packet is not the data of the preset type, encrypting the transmission data packet and transmitting the encrypted transmission data packet to the uplink network device.

19. A data processing method, the method comprising:
obtaining a preset data packet, and obtaining compressed data from the preset data packet, wherein the preset data packet is a data packet of a backhaul transport protocol;
decompressing the compressed data to obtain a standard data packet, wherein the standard data packet is a standard Internet Protocol data packet;
adapting the standard data packet to generate a transmission data packet, wherein the transmission data packet is a data packet of the backhaul transport protocol, and the backhaul transport protocol is a protocol for data transmission on a backhaul network between a base station and an uplink network device; and
performing protocol conversion on the transmission data packet to generate a wireless data packet, wherein the wireless data packet is a data packet of a wireless air interface protocol, and the wireless air interface protocol is a protocol for data transmission on a radio air interface.

20. The method according to claim 19, wherein adapting the standard data packet to generate the transmission data packet comprises:
adding a protocol header of a transport network layer of the backhaul transport protocol to the standard data packet to obtain the transmission data packet, wherein the transport network layer of the backhaul transport protocol is used to carry user data.

21. The method according to claim 19, wherein decompressing the compressed data to obtain a standard data packet comprises:
obtaining at least one data slice and at least one data digest from the compressed data, wherein one data slice corresponds to one data digest, and the data digest is a digest of a data slice corresponding to the data digest;
replacing a repeated data digest with a data slice corresponding to the repeated data digest, and combining the at least one data slice with the data slice corresponding to the repeated data digest to obtain application data; and
performing protocol encapsulation on the application data to generate the standard data packet.

22. The method according to claim 21, further comprising:
obtaining a data codebook, wherein the data codebook comprises a correspondence between the at least one data slice and the at least one data digest; and
replacing the repeated data digest with the data slice corresponding to the repeated data digest comprises:
replacing, according to the data codebook, the repeated data digest with the data slice corresponding to the repeated data digest.

23. The method according to claim 19, further comprising:
after performing protocol conversion on the transmission data packet to generate the wireless data packet, sending the wireless data packet to user equipment.

24. The method according to claim 19, further comprising:
after obtaining the preset data packet, determining whether the preset data packet is a data packet that has been compressed and optimized; and
when the preset data packet is not the data packet that has been compressed and optimized, converting the preset data packet into a data packet of the wireless air interface protocol and sending the data packet of the wireless air interface protocol to user equipment.
